(19) United States
(12) Patent Application Publication
(10) Pub. No.: US 2004/0204035 A1
(43) Pub. Date: Oct. 14, 2004

(54) Multi-mode mobile communications device and method employing simultaneously operating receivers

(76) Inventors: Sharada Raghuram, Buffalo Grove, IL (US); Donald Arthur Dorsey, Vernon Hills, IL (US); Kevin Spriggs, Chicago, IL (US)

Correspondence Address: VEDDER PRICE KAUFMAN & KAMMHOLZ, 222 N. LASALLE STREET, CHICAGO, IL, 60601, US

(21) Appl. No.: 10/253,328

(22) Filed: Sep. 24, 2002

(51) Int. Cl. H04B 1/00

(52) U.S. Cl. 455/553.1; 455/450

(57) ABSTRACT

A multi-mode wireless communication device (100) includes two separate receivers (130, 132) associated with two different radio access technologies and a multi-mode channel selection circuit (174). The first receiver (130) and second receiver (132) operate simultaneously to receive a first signal (150) on a first channel and a second signal (152) on a second channel respectively. The multi-mode channel selection circuit (174) then obtains from the first signal first cell selection information (950) and from the second signal second cell selection information (952). Then the multi-mode channel selection circuit (174) selects a suitable channel to camp on based on the first and second cell selection information (950, 952). The present invention also includes a method with the steps of receiving the first and second signals with simultaneously operating receivers (130, 132), obtaining first and second cell selection information (950, 952), and selecting a suitable channel to camp on based on the first and second cell selection information (950, 952).

### REFERENCE TO RELATED APPLICATIONS

This application is related to application Ser. No. 10/027,650 entitled “Multi-Mode Mobile Communication Device With Continuous Mode Transceiver and Method Therefore”, having inventors Christopher Leyh et al., filed on Dec. 21, 2001, assigned to the assignee of the present invention, and incorporated herein in its entirety by reference.

### BACKGROUND OF THE INVENTION

The present invention relates generally to wireless communications, and more particularly to multi-mode communication devices that have at least two receivers.

The recent emergence of 3rd Generation and higher mobile wireless communications systems creates a need for wireless communications devices capable of accessing multiple communications systems with different radio access technologies, for example GSM and W-CDMA communications systems serving a common geographical area.

The full exploitation of the services of multiple communication systems using different radio access technologies requires that multi-mode wireless communications devices operate simultaneously on more than one communication system and transition efficiently therebetween without significant performance degradation. Multi-mode and multi-band wireless communications devices are known, but presently these known devices are typically incapable of accessing more than one communication system simultaneously.

When a wireless communication device is powered up, it must first determine which channel to register on and monitor. This process of registering on and monitoring a channel is referred to as camping on the channel. A channel may be for example, a frequency, time slot, code (e.g., scrambling code), any suitable combination thereof, or other suitable communication mechanism. By camping on a channel the wireless communication device is able to listen for pages for incoming communications and data transfers. The process of finding a channel to camp on generally involves sequentially listening to the different channels until a suitable channel is found. Since presently known wireless communication devices are typically incapable of accessing more than one communication system using different radio access technologies simultaneously, the mobile wireless communication device must first listen to channels associated with one communication system and then listen to channels associated with another communication system. This can make the process of locating a channel to camp on lengthy.

Oftentimes, different communication systems available to a wireless communication device are owned by different service providers. For example, there may be several different service providers that provide service on CDMA communication systems and several other service providers that provide service on GSM communication systems. The different service providers are likely to charge different amounts of money for use of their communication systems. Hence, it is desirable for the wireless communication device to be able to choose a preferred service provider. One way of doing this is for the wireless communication device to build a list of available service providers. Generally this is done by scanning the available channels and recording what providers are available. Since presently known wireless communication devices are incapable of accessing more than one communication system using different radio access technologies simultaneously, the mobile wireless communication device must first listen to channels associated with one communication system and then listen to channels associated with another communication system. This can make the process of building a list of available service providers lengthy.

### BRIEF DESCRIPTION OF THE DRAWINGS

FIG. 1 illustrates a wireless mobile communications device according to an exemplary embodiment of the invention;

FIG. 2 illustrates one embodiment of an interface device for use in a wireless mobile communications device;

FIG. 3 is a flowchart illustrating a method for channel selection in a multi-mode wireless communication device in accordance with one embodiment of the present invention;

FIG. 4 is a flowchart illustrating a method for obtaining service provider information in a multi-mode wireless communication device in accordance with one embodiment of the present invention;

FIG. 5 is a flowchart illustrating a method for selecting a service provider in a multi-mode wireless communication device in accordance with one embodiment of the present invention;

FIG. 6 is a flowchart illustrating another method for channel selection in a multi-mode wireless communication device in accordance with one embodiment of the present invention;

FIG. 7 is a flowchart that is a continuation of the flowchart of FIG. 6;

FIG. 8 is a flowchart illustrating a method for obtaining service provider information in a multi-mode wireless communication device in accordance with one embodiment of the present invention; and

FIG. 9 is a block diagram illustrating one example of a multi-mode channel selection circuit in accordance with one embodiment of the invention.

### DETAILED DESCRIPTION OF A PREFERRED EMBODIMENT

A multi-mode wireless communication device includes two separate receivers: a first receiver associated with a first radio access technology, and a second receiver associated with a second radio access technology. The first and second radio access technologies may be for example CDMA and GSM. The second receiver simultaneously operates while the first receiver is operating. The first receiver receives a first signal on a first channel. The wireless communication device then obtains from the first signal first cell selection information. The cell selection information may be, for example, the signal strength of the first signal, a service provider associated with the first channel, a quality rating of the first signal, or the availability of the first channel for camping. A second signal is received by the second receiver on a second channel. The wireless communication device obtains from the second signal second cell selection information. Then the wireless communication device selects a suitable channel to camp on based on the first and second cell selection information. This selection may be made for example, based on the signal strength of the first and second signals, the quality ratings of the first and second signals, or the service providers associated with the first and second channels.

In another embodiment of the present invention the multi-mode wireless communication device obtains service provider information. Service provider information may include, for example, the identity of a service provider that provides communication services on a channel that the multi-mode wireless communication device receives. The multi-mode wireless communication device includes a first receiver associated with a first radio access technology and a second receiver associated with a second radio access technology. A first signal is received on a first channel with the first receiver. The multi-mode wireless communications device obtains from the first signal a first service provider, which is associated with the first channel. The multi-mode wireless communication device then determines if the first service provider should be added to a service provider list. This determination can be done, for example, by checking to see if the service provider is already on the service provider list. The second receiver simultaneously operates while the first receiver is operating. The second receiver receives a second signal on a second channel. The multi-mode wireless communication device then obtains from the second signal a second service provider associated with the second channel. The multi-mode wireless communication device then determines if the second service provider should be added to the service provider list. This determination may be done for example by checking to see if the second service provider is already on the service provider list.

In another embodiment of the present invention, the multi-mode wireless communication device selects a service provider. The multi-mode wireless communication device includes a first receiver associated with a first radio access technology and a second receiver associated with a second radio access technology. A first signal is received on a first channel with the first receiver. The multi-mode wireless communication device then obtains from the first signal first cell selection information. The first cell selection information includes a first service provider associated with the first channel. From the first cell selection information, the multi-mode wireless communication device determines whether the first channel is suitable to camp on. This determination may be made for example, if the signal strength of the first signal is high enough, if the quality of the first signal is high enough, or if a camping availability indication shows that the first channel is available for camping. If the first channel is suitable to camp on, the multi-mode wireless communication device determines if the first service provider should be added to a service provider list. This determination can be made, for example, by checking to see if the service provider is already on the service provider list. The second receiver simultaneously operates while the first receiver is operating. The second receiver receives a second signal on a second channel. The multi-mode wireless communication device obtains from the second signal second cell selection information. The second cell selection information includes a second service provider associated with the second channel. The multi-mode wireless communication device then determines from the second cell selection information whether the second channel is suitable to camp on. This determination may be made, for example, if the signal strength of the second signal is high enough, if the quality of the second signal is high enough, or if a camping availability indication shows that the second channel is available for camping. If the second channel is suitable to camp on, the multi-mode wireless communication device determines if the second service provider should be added to the service provider list. This determination can be done for example, by checking to see if the second service provider is already on the service provider list. The multi-mode wireless communication device then selects a service provider from the service providers on the service provider list. This selection can be done, for example, by selecting a home service provider as the service provider if the home service provider is on the service provider list, or by selecting a service provider from the service provider list that is highest in priority. A home service provider, in general, is one that the user of the multi-mode wireless communication device has a subscription for.

In yet another embodiment of the present invention, the multi-mode wireless communication device further includes a multi-mode channel selection circuit in addition to the first and second receivers. The multi-mode channel selection circuit includes a cell selection information parser circuit and a multi-mode channel determination circuit. The cell selection information parser circuit is operable to receive first and second signals from the first and second receivers and obtain from the first and second signals first and second cell selection information. The multi-mode channel determination circuit is operable to select a suitable channel for the multi-mode wireless communication device to camp based at least on the first and second cell selection information.

Among other advantages, the present invention allows a multi-mode wireless communication device to more quickly select a channel or collect service provider information. This is done by simultaneously operating receivers using two different radio access technologies. This can decrease the time that a user of a wireless communication device must wait while the device selects a channel or service provider. The multi-mode wireless communication device is also able to conserve battery power by selecting a channel or collecting service provider information quicker.

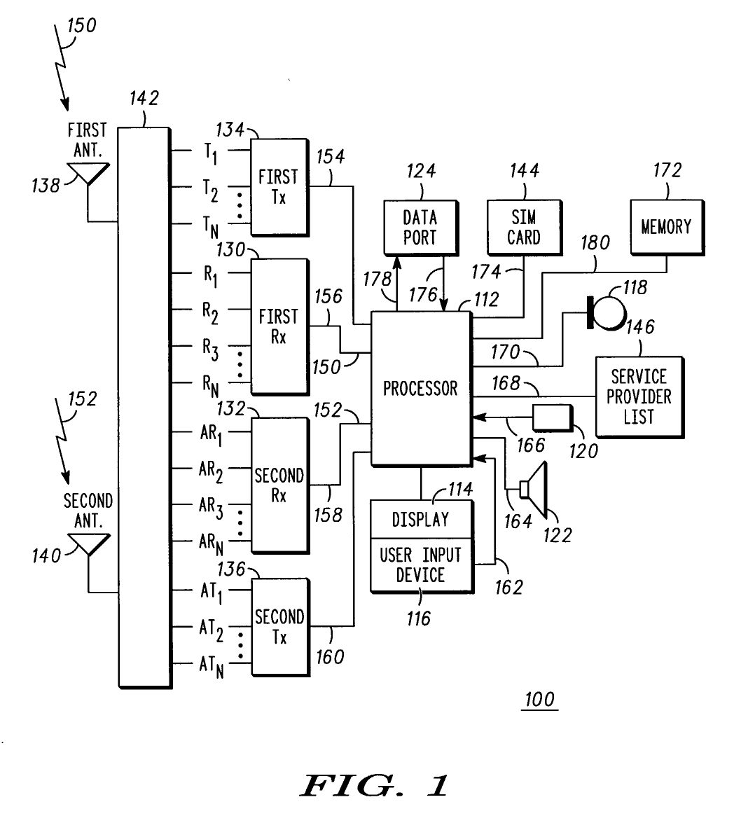

FIG. 1 illustrates a multi-mode wireless communication device 100 in accordance with one embodiment of the present invention. The multi-mode wireless communication device 100 may be, for example, a cellular phone, pager, two-way radio, computer equipped with a wireless modem, personal digital assistant, Internet appliance, data terminal, or any other suitable device. The multi-mode wireless communication device 100 includes first and second antennas 138, 140, first and second transmitters 134, 136, first and second receivers 130, 132, an interface device 142, a processor 112, a display 114, a user input device 116, a memory 172, a speaker 122, a video input device 120, a input/output data port 124, a microphone 118, a SIM card 144, and a service provider list 146. The various elements of the multi-mode wireless communication device 100 are linked by a plurality of links 154-180. The links 154-180 may be any suitable means for conveying electrical signals.

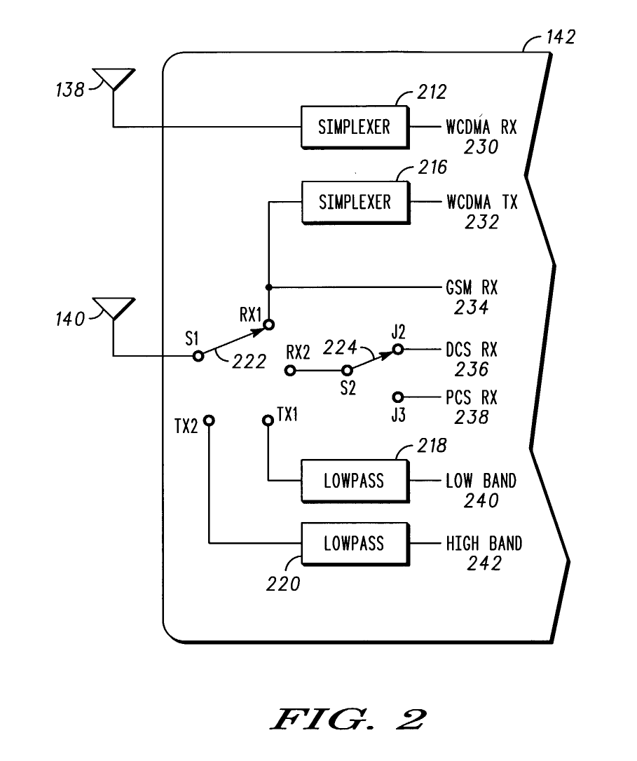

The first antennae 138 and second antennae 140 may be any suitable antennas as are known in the art for receiving and transmitting signals to and from the multi-mode wireless communication device 100. The first antenna 138 and second antenna 140 may, in general, be either internal or external to the multi-band wireless communication device 100. In one embodiment, the first antenna 138 is an internal antenna and the second antenna 140 is an external antenna. The first and second antennas 138, 140 are coupled to the interface device 142. The interface device is also coupled to the first and second transmitters 134, 136 and the first and second receivers 130, 132. The interface device 142 routes signals between the first and second antennas 138, 140; the first and second transmitters 134, 136; and first and second receivers 130, 132. An exemplary interface device 142 is described below with respect to FIG. 2.

The first transmitter 134 is operable to transmit signals associated with a first radio access technology. The second transmitter 136 is operable to transmit signals associated with a second radio access technology. Radio access technologies may include for example, Code Division Multiple Access (CDMA), Global System for Mobile Communications (GSM), Advanced Mobile Phone Service (AMPS), Integrated Dispatched Enhanced Network (IDEN), other spread spectrum technologies, or any other suitable radio access technology. Transmitters of these radio access technologies are known in the art.

The first receiver 130 is operable to receive signals associated with the first radio access technology. The second receiver 132 is operable to receive signals associated with the second radio access technology. Radio access technologies may include for example, Code Division Multiple Access (CDMA), Global System for Mobile Communications (GSM), Advanced Mobile Phone Service (AMPS), Integrated Dispatched Enhanced Network (IDEN), other spread spectrum technologies, or any other suitable radio access technology. Receivers of these radio access technologies are known in the art.

In the embodiment of FIG. 1, the multi-mode wireless communications device 100 includes the first receiver 130 having a plurality of receiver inputs R1, R2, R3 . . . RN, and the second receiver 132 having a plurality of receiver inputs AR1, AR2, AR3 . . . ARN. The multi-mode wireless communications device 100 also includes a first transmitter 134 having a plurality of outputs T1, T2 . . . TN, and a second transmitter 136 having a plurality of transmitter outputs AT1, AT2 . . . ATN. The two receivers each have a corresponding transmitter, although in some embodiments there also may be receivers and/or transmitters without a counterpart transmitter or receiver, for example a Global Position System (GPS) receiver, or an emergency locating transmitter.

In the present invention, the first transmitter 134 and second transmitter 136 are associated with different radio access technologies. Likewise the first receiver 130 and the second receiver 132 associated with different radio access technologies. The first receiver 130 and first transmitter 134 together make up a first transceiver. Similarly, the second receiver 132 and second transmitter 136 together make up a second transceiver. For example, in one embodiment the first transmitter 134 is a CDMA transmitter and the second transmitter 136 is a GSM transmitter. Similarly, the first receiver 130 is a CDMA receiver and the second receiver 132 is a GSM receiver. As is known in the art, GSM is a time division multiple access (TDMA) radio access technology. In GSM, each frequency (e.g., channel) is shared among multiple wireless communication devices by dividing the frequency into blocks of time. Hence, each receiver in a GSM wireless communication device does not continuously receive a GSM signal. In contrast, CDMA is a continuous reception mode radio access technology. When a CDMA receiver in a wireless communication device is receiving a CDMA signal, it continuously receives the signal because the frequency is not divided into blocks of time to be shared among multiple wireless communication devices. Other continuous reception mode receivers include, for example, wideband CDMA, CDMA 2000, AMPS, or some other spread spectrum receivers.

In other embodiments of the present invention, the wireless communication device 100 may use other radio access technologies other than CDMA and GSM. For example, the first transmitter 134 and first receiver 130 may use wideband CDMA (W-CDMA) while the second receiver 132 and second transmitter 136 may use CDMA 2000. In another embodiment, the first transmitter 134 and first receiver 130 use AMPS while the second receiver 132 and second transmitter 136 use GSM. As will be appreciated, the transmitters and receivers of the multi-mode wireless communication device 100 may in general use any wireless access technologies. However, in all embodiments the first receiver 130 and the second receiver 132 are of different radio access technologies.

In one embodiment, one receiver is a continuous reception mode receiver. The continuous reception mode receiver is coupled to one antenna and the other receiver, which may or may not be a continuous reception mode receiver, is coupled to another, different antenna. In one mode of operation, the continuous reception mode receiver is capable of receiving signals at the same time that the other receiver receives signals. In one embodiment, the other receiver is a continuous reception mode receiver, for example a CDMA receiver, or alternatively the other receiver may be some other type of receiver, for example a TDMA receiver.

In one mode of operation, a first signal 150 is received with the first receiver 130 of the first transceiver operating in a continuous reception mode, and a second signal 152 is received with a second receiver 132 of the second transceiver at the same time the first receiver 130 is receiving the first signal to determine cell selection.

In a related receive mode of operation, the first signal 150 is a downlink signal received by the first receiver 130 operating in the continuous reception mode, and the second signal is received by the second receiver 132 operating in a non-continuous reception mode at the same time the first receiver 130 is receiving the downlink signal. In one application, the multi-mode wireless communications device 100 operates in CDMA and TDMA communications systems, for example WCDMA and GSM systems, wherein the CDMA receiver receives the downlink and the TDMA receiver simultaneously receives the second signal.

In another related receive/receive mode of operation, both the first and second receivers 130, 132 are continuous mode receivers, for example CDMA receivers, wherein the first receiver 130 receives a first downlink signal and the second receiver 132 simultaneously receives a second downlink signal.

In another mode of operation (such as after cell selection is complete, e.g., during a registration process, during a voice or data call or other post cell selection communication), a first signal 150 is received by the first receiver 130 operating in a continuous reception mode, and a second signal 152 is transmitted by the second transmitter 136 at the same time the first receiver 130 is receiving the first signal 150.

In a related receive/transmit mode of operation, the first signal 150 is an downlink signal received by the first receiver 130 operating in the continuous reception mode, and the second signal 152 is transmitted by the second transmitter 136 operating in a non-continuous transmit mode at the same time the first receiver 130 is receiving the downlink signal. In one application, the multi-mode wireless communications device 100 operates in CDMA and TDMA communications systems, for example WCDMA and GSM systems, wherein the CDMA receiver receives the downlink and the TDMA transmitter simultaneously transmits the second signal 152. In some embodiments, the TDMA transceiver is a multi-band transceiver capable of transmitting in any bands at the same time the CDMA receiver receives the downlink signal.

In another mode of operation, the first signal 150 is transmitted with the first transmitter 134 of the first transceiver operating in a continuous transmission mode, and the second signal 152 is received by a second receiver 132 of the second transceiver at the same time the first transmitter 134 is transmitting the first signal 150.

In a related transmit/receive mode of operation, a uplink signal is transmitted with a first transmitter 134 operating in a continuous transmit mode, and the second signal 152 is received with the second receiver 132 at the same time the first transmitter 134 transmits the uplink first signal 150. In one application, the first transmitter 134 is a CDMA transmitter and the second receiver 132 is a TDMA receiver, for example a multi-mode GSM transceiver capable of receiving and transmitting in PCS and DCS bands and transmitting in high and low bands.

The first transmitter 134, first receiver 130, second receiver 132, and second transmitter 136 are all linked to a processor 112. The processor 112 may be any kind of processing device such as a microprocessor, central processing unit, digital signal processor, state machine, or any other suitable device. The processor receives from and sends signals to the various elements of the multi-mode wireless communication device 100 over the links 154-176.

In one embodiment of the present invention, the processor 112 contains a multi-mode channel selection circuit 174. The multi-mode channel selection circuit 174 may be implemented in hardware as an integrated circuit that is integrated within the processor 112 or in other embodiments it may be an integrated circuit that is separate from the processor 112. Alternately, the multi-mode channel selection circuit may be implemented as software routines that are stored within the memory 172 and are executed by the processor 112. One of the functions of the multi-mode channel selection circuit 174 is channel selection. Channel selection is the process by which the multi-mode wireless communication device 100 chooses a channel to register on and monitor. The multi-mode wireless communication device 100 must register on a channel and monitor the channel so that it may receive incoming signals containing pages, phone calls, data, etc. The process of registering on and monitoring a channel is referred to as camping on the channel.

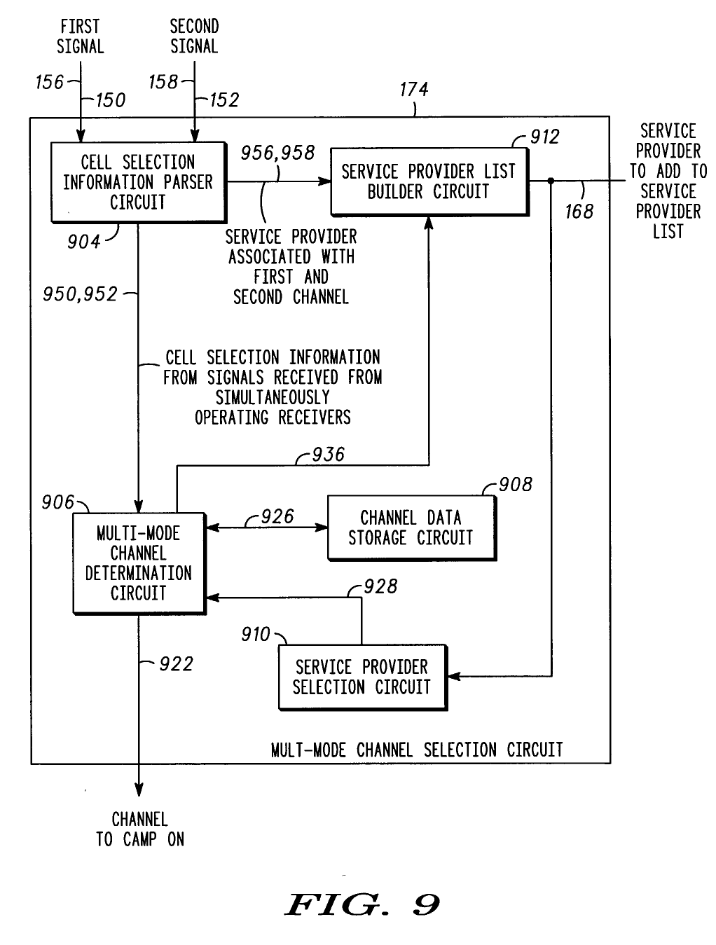

FIG. 9 is a block diagram illustrating one example of the multi-mode channel determination circuit 174 which includes a cell selection information parser circuit 904, a multi-mode channel determination circuit 906, a service provider list builder circuit 912, a service provider selection circuit 910, and a channel data storage circuit 908. Each of these circuits included in the multi-mode channel determination circuit 174 may be implemented as software routines that are stored within memory 172 and are executed by one or more processors. In this example, processor 112 is used. Alternately, each of these circuits included in the multi-mode channel determination circuit 174 may be implemented in hardware as a circuit that is integrated within the multi-mode channel determination circuit 174. In other embodiments they each may be separate integrated circuits. They also may be grouped together within multiple integrated circuits. For example, the service provider list builder circuit 912 and the service provider selection circuit 910 may be grouped together as an integrated circuit that is separate from the processor 112.

The cell selection information parser circuit 904 receives the first signal 150 and second signal 152. The first signal 150 is received by the first receiver 130 of the first radio access technology on a first channel via the first antenna 138. The second signal 152 is received by the second receiver 132 of the second radio access technology on a second channel via the second antenna 140. The second receiver 132 simultaneously operates to receive the second signal 152 while the first receiver 130 operates to receive the first signal 150. The first and second receivers 130, 132 demodulate the first and second signals 150, 152 as is known in the art. The demodulated first and second signals 150, 152 are then sent by the first and second receivers 130, 132 to the cell selection information parser circuit 904.

The cell selection information parser circuit 904 obtains first cell selection information 950 from the first signal 150 and second cell selection information 952 from the second signal 152. The first and second cell selection information 950, 952 may include, for example, a quality rating of the first signal, a service provider associated with the first channel, a camping availability indication, an signal strength of the first signal, or any other suitable cell selection information. The quality rating may be, for example, the C1 parameter as is commonly used for a GSM signals or the S parameter as is commonly used for CDMA signals, as known in the art. The C1 and S parameters are measurements of the quality of the received signal. A camping availability indication shows whether the channel is available for use for camping. Certain channels may be designated as unavailable for camping by the service provider associated with the channel. Signal strength (e.g., received signal strength indication (RSSI)) is a measure of the strength of the received signals and may be determined using techniques well known in the art. The cell selection information may be obtained from the first and second signals in a number of different ways. For example, the signal strength or quality parameter may be calculated by the cell selection information parser circuit 904 as is known in the art. The service provider associated with the first channel or camping availability indication may be obtained by the cell selection information parser circuit 904 by reading the cell selection information from the demodulated signal.

The service provider list builder circuit 912 is coupled to the cell selection information parser circuit 904 and the service provider selection circuit 910. The service provider list builder circuit 912 receives a first service provider 956 associated with the first channel and a second service provider 958 associated with the second channel. The service provider list builder circuit 912 also receives an indication 936 as to whether the first channel and second channel are suitable to camp on from the multi-mode channel determination circuit 906. The service provider list builder circuit 912 determines whether the first service provider 956 associated with the first channel should be added to the service provider list 146. The service provider list builder circuit 912 also determines whether the second service provider 956 associated with the second channel should be added to the service provider list 146. The determination of whether to add a service provider to the service provider list 146 can be made, for example, by checking the indication sent from the multi-mode channel determination circuit 906 to see whether the channel with which the service provider is associated is suitable for camping. If it is suitable for camping, a check is made to see whether the service provider is already on the service provider list 146. If the service provider is not on the service provider list 146, the service provider list builder circuit 912 adds the service provider to the service provider list 146. The service provider list 146 records which service providers are available to the multi-mode wireless communication device 100. The service provider list 146 in general will reside in memory that is linked to the service provider list builder circuit 912.

Service providers are companies or organizations that provide wireless communication service to wireless communication devices. Usually, there are multiple service providers available to a wireless communication device. The multiple available service providers may use the same radio access technology or they may use different radio access technologies. One of the service providers may be a home service provider for the multi-mode wireless communication device 100. A home service provider is one that the user of the multi-mode wireless communication device 100 has a subscription for. In general, communication service provided by the home service provider will be less expensive than communication services provided by other service providers. A user of the multi-mode wireless communication device 100 may also have a list of preferred service providers. In general, communication services provided by the preferred service providers will be less expensive than communication services provided by other service providers. Therefore, the multi-mode wireless communication device 100 will attempt to choose a service provider that is either a home service provider or a preferred service provider.

In order to select a service provider, the multi-mode wireless communication device 100 will have to first determine what service providers are available, this is accomplished by scanning the available channels with the first receiver 130 and second receiver 132 and recording what service providers are providing communication services on those channels. The available service providers are recorded on the service provider list 146. The service provider list 146 in general will reside in memory, which is linked to the processor 112.

The service provider selection circuit 910 is coupled to the service provider list 146 and the multi-mode channel determination circuit 906. The service provider selection circuit 910 selects a service provider for the multi-mode wireless communication device 100 from the service providers on the service provider list 146. The selection of the service provider can be done in a number of different ways. For example, if one of these service providers on the service provider list 146 is a home service provider for the multi-mode wireless communication device 100, the service provider selection circuit 910 may select the home service provider. Alternatively, the multi-mode wireless communication device 100 may have a preferred service provider list. The preferred service provider list contains a listing of service providers in order of priority. The service provider selection circuit 910 would then select the service provider on the service provider list 146 that is highest in priority on the preferred service provider list.

The multi-mode channel determination circuit 906 is coupled to the cell selection information parser circuit 904, the service provider selection circuit 910, the channel data storage circuit 908, and the service provider list builder circuit 912, the first receiver 130, and the second receiver 132. The multi-mode channel determination circuit 906 selects which channel the multi-mode wireless communication device 100 will camp on. The multi-mode channel determination circuit 906 selects the channel to camp on based at least on the first and second cell selection information 950, 952 that was obtained from the first and second signals that were received by the first and second receivers 130, 132 simultaneously. As part of the process of selecting a channel to camp on, the multi-mode channel determination circuit 906 first determines whether each channel is suitable to camp on based on the corresponding cell selection information 950, 952. A signal may not be suitable to camp on if the quality rating of the signal is too low, if the signal strength is too low, or if the camping availability indication shows that the signal is not available for camping. The multi-mode channel determination circuit 906 then notifies, through indication 936, the service provider list builder circuit 912 whether a particular channel is suitable for camping. Once the multi-mode channel determination circuit 906 has selected a channel to camp on, it notifies the receiver associated with the radio access technology associated with that channel 922 to camp on that channel.

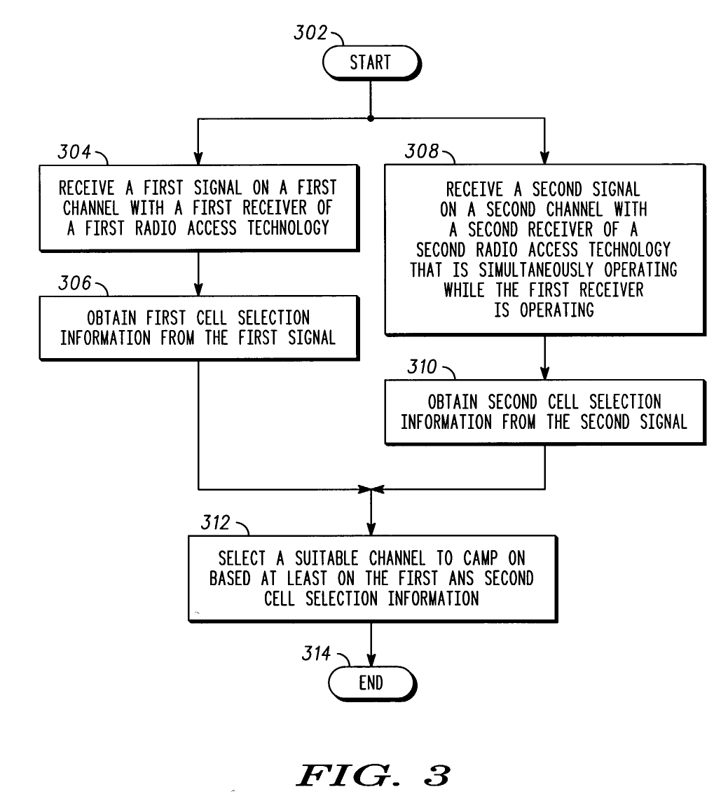

The multi-mode channel determination circuit 906 can select a channel to camp on in a number of different ways. For example, the multi-mode wireless communication device 100 may determine that one of the channels is not suitable to camp on based on the cell selection information 950, 952. If one of the signals is not suitable for camping, then the multi-mode wireless communication device 100 will not choose the channel for that signal. If both of the signals are suitable for camping, the multi-mode wireless communication device 100 may select the suitable channel for camping based on for example, which of the radio access technologies is preferred or by which of the service providers associated with the different channels is preferred. For example, the service provider selection circuit 910 may instruct, via notification 928, the multi-mode channel determination circuit 906 to choose a channel associated with a particular desired service provider such as a home service provider. In that case if one of the channels is associated with the desired service provider and it is suitable to camp on, that channel will be selected. As another example, the multi-mode wireless communication device 100 may have a preferred service provider list. The service provider selection circuit 910 would then instruct the multi-mode channel determination circuit 906 to select a channel associated with the service provider with the highest priority on the preferred service provider list. The methods of FIGS. 3-8 illustrate in more detail how the multi-mode channel determination circuit 906 can select a channel to camp on and how the service provider selection circuit 910 selects a service provider for the multi-mode wireless communication device 100.

The channel data storage circuit 908 is coupled to the multi-mode channel determination circuit 906. The channel data storage circuit 908 stores data representing the first channel when the first radio access technology is not preferred and the first channel is suitable to camp on. Alternatively, the channel data storage circuit 908 stores data representing the second channel when the second radio access technology is not preferred and the second channel is suitable to camp on. In general, the multi-mode wireless communication device 100 will have a preferred radio access technology. As the multi-mode channel determination circuit 906 examines the cell selection information 950, 952 for the different received signals, it may discover that a channel for a desired service provider is suitable to camp on but the radio access technology for that channel is not the preferred radio access technology. In that case, the channel data storage circuit 908 will store data 926 representing the channel. If the multi-mode channel determination circuit 906 is not able to locate a suitable channel to camp on that is associated with the preferred access technology, the multi-mode channel determination circuit 906 will have the multi-mode wireless communication device 100 camp on the channel represented by the stored data using the non-preferred radio access technology.

The processor 112 is coupled to the memory 172. The memory may be integrated within the processor 112 or may be separate from the processor 112. The memory 172 may be RAM, ROM, floppy disk, optical disk, DVD ROMS, CD ROMS, or any other suitable memory.

The processor 112 is coupled to a display 114. Such a display may be, for example, a liquid crystal display, light emitting diode display, cathode ray tube, or any other suitable display device. The processor 112 is also coupled to a speaker 122. The speaker 122 is any device capable of producing audible sounds. The processor 112 is also linked to a user input device 116. The user input device 116 may be a keyboard, numeric keypad, or some other suitable user input device. The processor 112 is also linked to a microphone 118. The microphone 118 may be any suitable device for converting sound into an electrical signal as is known in the art. The processor 112 may also be coupled to a video input device 120. Such a video input device 120 may be, for example, a camera. The processor 112 is also linked to a data port 124. The data port 124 is an interface that allows the multi-mode wireless communication device 100 to be connected to another device such as a computer, data terminal, or other suitable device. The data port may use a physical connection, an infrared link, or a wireless connection to connect to the other device. It will be appreciated that in alternate embodiments the multi-mode wireless communication device 100 may not include one or more of the display 114, user input device 116, speaker 122, video input device 120, microphone 118, or data port 124. In other embodiments the multi-mode wireless communication device 100 may have other elements not shown in FIG. 1.

The multi-mode wireless communication device 100 also contains a SIM card 144 coupled to the processor 112. The SIM card 144, as known in the art, is a device containing memory for storing information related to a user of the multi-mode wireless communication device 100. Such information may include, for example, a phone number of the multi-mode wireless communication device, a home service provider of the multi-mode wireless communication device 100, a list of preferred service providers for the multi-mode wireless communication device 100, the cost of communication service (rate structure), or other relevant information. As is known in the art, the SIM card 144 is removable from the multi-mode wireless communication device 100. This allows a user of the multi-mode wireless communication device 100 to move the SIM card from one wireless communication device to another and maintain the same information such as the same phone number, service provider, etc.

FIG. 2 illustrates an exemplary embodiment of the interface device 142 for the multi-mode wireless communication device 100. In FIG. 2, the interface device 142 links the two antennas 138, 140 to ports 230-242 for a wideband CDMA receiver and transmitter, such as the first receiver 130 and first transmitter 134 (see FIG. 1), and a GSM receiver and transmitter, such as the second receiver 132 and second transmitter 136. In this embodiment, the GSM receiver is a multiband receiver that is capable of receiving channels on two separate channel bands. Likewise, the GSM transmitters are multiband transmitters that are capable of transmitting GSM signals in two separate channel bands. The wideband CDMA receiver port 230 is connected to the first antenna 138 through a simplexer 212. Wideband CDMA simplexers are known in the art. The second antenna 140 is connected by a switch 222 to the wideband CDMA transmitter port 232, GSM receiver port 234, DCS receiver port 236, PCS receiver port 238, GSM high band transmitter port 242, and GSM low band transmitter port 240. The wideband CDMA transmitter port 232 is connected through a second simplexer 216 to the switch 222. The low band GSM transmitter port 240 is connected to the switch 222 through a low pass filter 218. The high band GSM transmitter is connected to the switch through a second low pass filter 220. Low pass filters are known in the art. As mentioned previously, the GSM receiver is a multiband GSM receiver that is capable of receiving frequencies in two frequency bands. The GSM receiver may be connected to the antenna 140 using two different methods. The first method connects the GSM receiver through the switch 222 to the antenna 140 so that it receives a frequency band at GSM receiver port 234. Alternately, the GSM receiver can receive the signals from the antenna 140 through the switch 222 in only one of the frequency bands. This is done through the use of a second switch 224 which routes the signal from the antenna 140 to either the DCS receiver port 236 or PCS receiver port 238.

FIG. 3 is the flow chart illustrating a method for channel selection in the multi-mode wireless communication device 100. This method can be used by the multi-mode wireless communication device 100 to locate a channel to register on and monitor. This process of registering on and monitoring a channel is referred to as camping on the channel. This method may be used by the multi-mode wireless communication device 100 when it first powers up or when it is no longer able to receive signals on the channel that it was previously camped on. The method begins with steps 304 and 308, which are executed simultaneously. In step 304 a first signal is received on a first channel with a first receiver 130 associated with a first radio access technology. The first radio access technology may be for example, CDMA, GSM, wideband CDMA, AMPS, IDEN, CDMA 2000, or any other suitable radio access technology.

At step 306 the multi-mode wireless communication device 100 obtains first cell selection information from the first signal. The cell selection information may include, for example, a quality rating of the first signal, a service provider associated with the first channel, a camping availability indication, an signal strength of the first signal, or any other suitable cell selection information. The quality rating may be, for example, the C1 parameter as is commonly used for a GSM signals or the S parameter as is commonly used for CDMA signals. The C1 and S parameters are measurements of the quality of the received signal. A camping availability indication shows whether the channel is available for use for camping. Certain channels may be designated as unavailable for camping by the service provider associated with the channel. signal strength is a measure of the strength of the received signals as is well known in the art. The first cell selection information may be obtained from the first signal in a number of different ways. For example, the signal strength or quality parameter may be calculated by the first receiver 130 or cell selection information parser circuit 904 as is known in the art. The service provider associated with the first channel or camping availability indication may be obtained by the first receiver 130 demodulating the first signal and the cell selection information parser circuit 904 reading the cell selection information from the demodulated signal.

In step 308 a second signal is received by the second receiver 132 associated with a second radio access technology that is simultaneously operating while the first receiver 130 is operating. The second radio access technology may be for example, GSM, CDMA, wideband CDMA, CDMA 2000, AMPS, IDEN, or any other suitable radio access technology. However, it should be noted that the first radio access technology and the second radio access technology are different radio access technologies. At step 310, the multi-mode wireless communications device 100 obtains second cell selection information from the second signal. The second cell selection information may include a quality rating of the signal, a service provider associated with the second channel, a camping availability indication, and the signal strength of the second signal. The second cell selection information may be obtained from the second signal in a number of different ways. For example, the signal strength or quality parameter may be calculated by the second receiver 132 or the processor 112 as is known in the art. The service provider associated with the second channel or camping availability indication may be obtained by the second receiver 132 demodulating the first signal and the processor reading the cell selection information from the demodulated signal.

Following steps 306 and 310, in step 312 the multi-mode wireless communications device 100 selects a suitable channel to camp on based at least on the first and second cell selection information. In general, the channel selection will be made by the multi-mode channel determination circuit 906. The channel selection may be made in a number of different ways. For example, the multi-mode wireless communication device 100 may determine that one of the channels is not suitable to camp on based on the cell selection information. A signal may not be suitable to camp on if the quality rating of the signal is too low, if the signal strength is too low, or if the camping availability indication shows that the signal is not available for camping. If one of the signals is not suitable for camping, then the multi-mode wireless communication device 100 will choose the other signal.

If both of the signals are suitable for camping, the multi-mode wireless communication device 100 may select the suitable channel for camping based on for example, which of the radio access technologies is preferred or by which of the service providers associated with the different channels is preferred. For example, a home service provider may be preferred over other service providers. In that case if one of the channels is associated with the home service provider and it is suitable to camp on, that channel will be selected. As another example, the multi-mode wireless communication device 100 may have a preferred services provider list. The preferred service provider list lists a number of different service providers in order of priority. The multi-mode wireless communication device 100 will choose the service provider that has the highest priority on the preferred service provider list.

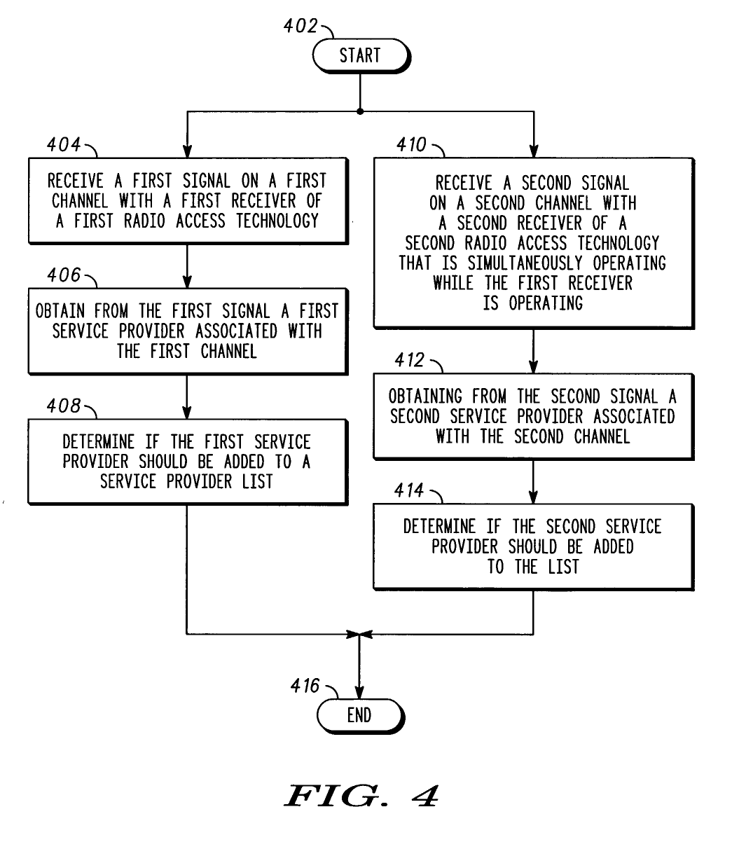

FIG. 4 is a flow chart illustrating a method for obtaining service provider information in the multi-mode wireless communication device 100. Service provider information includes the identity of a service provider associated with a channel. A service provider is associated with a channel when the service provider provides communication service over that channel. The method begins simultaneously with steps 404 and 410. In step 404 a first signal 150 is received on a first channel with a first receiver 130 associated with a first radio access technology. The first radio access technology may be, for example, CDMA, GSM, wideband CDMA, CDMA 2000, AMPS, IDEN, or any other suitable radio access technology. In step 406 the cell selection information parser circuit 904 of the multi-mode wireless communication device 100 then obtains a first service provider associated with the first channel from the first signal. The first service provider associated with the first channel may be obtained by the multi-mode communication device 100 in a number of different ways. The first receiver 130 may obtain the first service provider by demodulating the received first signal 150, as is known in the art and reading the first service provider from the demodulated signal. The first receiver 130 would then send the first service provider to the cell selection information parser circuit 904. The first service provider may also be obtained by the cell selection information parser circuit 904 receiving the demodulated first signal 150 from the first receiver 130 and reading the first service provider from the demodulated signal.

In step 408, the service provider list builder circuit 912 of the multi-mode wireless communication device 100 determines if the first service provider should be added to a service provider list 146. The service provider list 146 lists the available service providers from which the multi-mode wireless communication device 100 may choose a service provider. The service provider list 146 comprises a list of channels, radio access technologies associated with each of the channels, and a service provider associated with each of the channels. The service provider list builder circuit 912 may make the determination of whether to add the first service provider to the service provider list in a number of ways. For example, the first service provider may be added to the service provider list 146 if it is not already on the service provider list 146. The service provider is then added to the service provider list 146 if it is not already on the service provider list 146. Note that the service provider list builder circuit 912 does not add the service provider to the service provider list 146 if the channel with which the service provider is associated is not suitable for camping.

In step 410, a second signal is received on a second channel with the second receiver 132 associated with a second radio access technology that is simultaneously operating while the first receiver 130 is operating. The second radio access technology may be, for example, CDMA, GSM, CDMA 2000, wideband CDMA, AMPS, IDEN, or any other suitable wireless access technology. However, the first radio access technology and the second radio access technology are not the same radio access technologies. In step 412 the multi-mode wireless communication device 100 obtains a second service provider associated with the second channel from the second signal. The cell selection information parser circuit 904 of the multi-mode wireless communication device may obtain the second service provider in substantially the same manner as the first service provider was obtained.

In step 414, the service provider list builder circuit 912 of the multi-mode wireless communication device 100 determines if the second service provider should be added to the service provider list 146. The multi-mode wireless communication device 100 may make the determination of whether to add the second service provider to the service provider list 146 in a number of ways. For example, the second service provider may be added to the service provider list 146 if it is not already on the service provider list. The service provider is then added to the service provider list 146 if it is not already on the service provider list 146. Note that the service provider list builder circuit 912 does not add the service provider to the service provider list 146 if the channel with which the service provider is associated is not suitable for camping.

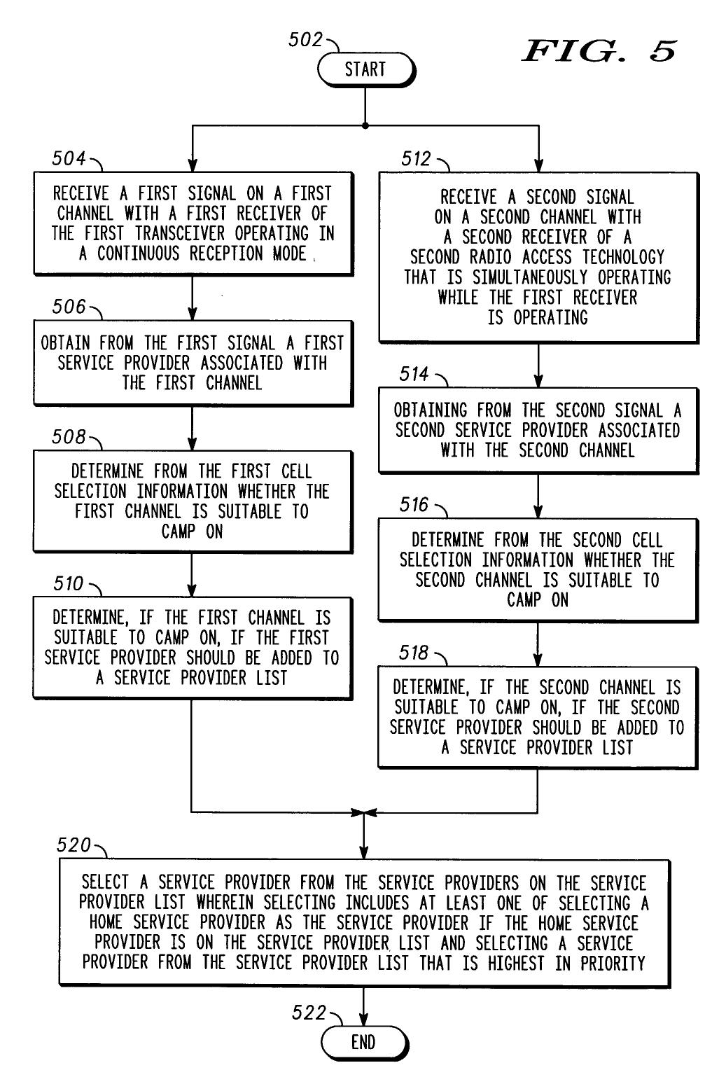

FIG. 5 is a flow chart illustrating a method for selecting a service provider in the multi-mode wireless communication device 100. The method begins with steps 504 and 512 that are executed simultaneously. In step 504, a first signal 150 is received on a first channel with the first receiver 130 associated with a first radio access technology. The first radio access technology may be, for example, CDMA, GSM, wideband CDMA, CDMA 2000, AMPS, IDEN, or any other suitable wireless access technology. In step 506, the cell selection information parser circuit 904 of the multi-mode wireless communication device 100 obtains first cell selection information 950 from the first signal. The first cell selection information includes a first service provider 956 associated with the first channel. The first service provider associated with the first channel may be obtained by the multi-mode communication device 100 in a number of different ways. The first receiver 130 may obtain the first service provider 956 by demodulating the received first signal, as is known in the art and reading the first service provider from the demodulated signal. The first receiver 130 would then send the first service provider 956 to the cell selection information parser circuit 904. The first service provider 956 may also be obtained by the cell selection information parser circuit 904 receiving the first signal from the first receiver 130, demodulating the first signal 150 as is known in the art, and reading the first service provider 956 from the demodulated signal.

In step 508, the multi-mode wireless communication device 100 determines if the first channel is suitable to camp on. This determination may be made in a number of different ways. For example, the first channel may be found suitable to camp on if the signal strength of the first signal 150 is strong enough, if the quality rating of the first signal 150 is high enough, if a camping availability indication shows that the first channel is available for camping, or by any other suitable method. In step 510, if the first channel is suitable to camp on, the service provider list builder circuit 912 of the multi-mode wireless communication device 100 determines if the first service provider 956 should be added to the service provider list 146. This determination may be made, for example, if the first service provider is not already on the service provider list 146. The first service provider 956 is then added to the service provider list 146 if it is not already on the service provider list 146.

In step 512, a second signal 152 is received on a second channel with the second receiver 132 associated with a second radio access technology. The second radio access technology may be, for example, CDMA, GSM, wideband CDMA, CDMA 2000, AMPS, IDEN, or any other suitable wireless access technology. In step 514 the cell selection information parser circuit 904 of the multi-mode wireless communication device 100 obtains second cell selection information 952 from the second signal 152. The second cell selection information 952 includes a second service provider 958 associated with the second channel. The second service provider 958 associated with the second channel may be obtained by the multi-mode communication device 100 in a number of different ways. The second receiver 132 may obtain the second service provider by demodulating the received second signal, as is known in the art and reading the second service provider from the demodulated signal. The second receiver 132 would then send the second service provider to the cell selection information parser circuit 904. The second service provider may also be obtained by the cell selection information parser circuit 904 receiving the second signal 152 from the second receiver 132, demodulating the second signal as is known in the art, and reading the second service provider 958 from the demodulated signal.

In step 516, the multi-mode channel determination circuit 906 of the multi-mode wireless communication device 100 determines if the second channel is suitable to camp on. This determination may be made in a number of different ways. For example, the second channel may be found suitable to camp on if the signal strength of the first signal is strong enough, if the quality rating of the second signal is high enough, if a camping availability indication shows that the second channel is available for camping, or by any other suitable method. In step 518, if the second channel is suitable to camp on, the service provider list builder circuit 912 of the multi-mode wireless communication device 100 determines if the second service provider 958 should be added to the service provider list 146. This determination may be made, for example, if the second service provider 958 is not already on the service provider list 146.

In step 520, the service provider selection circuit 910 of the multi-mode wireless communication device 100 selects a service provider from the service providers on the service provider list 146. This selection may be made in a number of different ways. For example, the multi-mode wireless communication device 100 may select a home service provider. The home service provider is the service provider that the user of the multi-mode wireless communication device 100 has a subscription for. The multi-mode wireless communication device 100 can select the home service provider as a service provider for the multi-mode wireless communication device 100 if it is on the service provider list 146. The multi-mode wireless communication device 100 may also have a preferred service provider list. The preferred service provider list lists a number of different service providers in order of preference. The multi-mode wireless communication device 100 may then select the service provider from the service provider list 146 that is highest on the preferred service provider list.

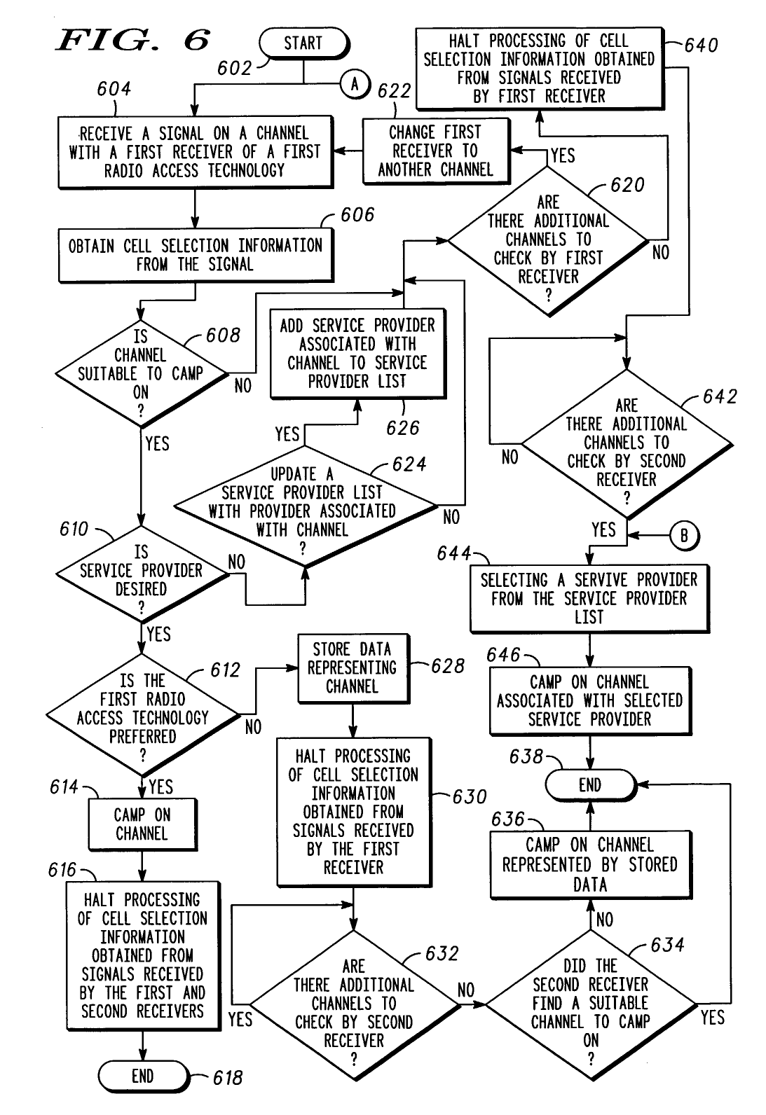

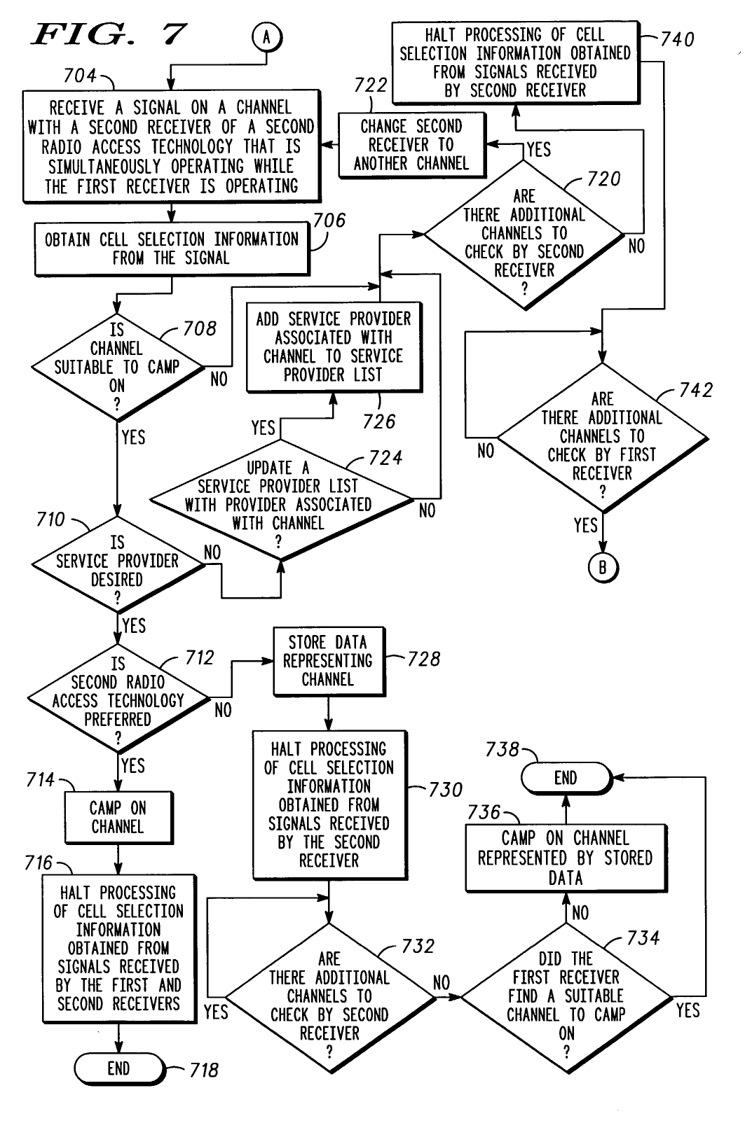

FIGS. 6-7 are flow charts illustrating a method for channel selection in the multi-mode wireless communication device 100. The method begins with steps 604 of FIG. 6 and step 704 of FIG. 7 which are executed simultaneously. In step 604, the first receiver 130 associated with a first radio access technology receives a signal on a channel. The first radio access technology may be, for example, CDMA, GSM, wideband CDMA, CDMA 2000, AMPS, IDEN, or any other suitable radio access technology. In step 606, the multi-mode wireless communication device 100 obtains cell selection information from the signal. The cell selection information may include, for example, a quality rating of the first signal, a service provider associated with the first channel, a camping availability indication, an signal strength of the first signal, or any other suitable cell selection information. The quality rating may be, for example, the C1 parameter as is commonly used for a GSM signals or the S parameter as is commonly used for CDMA signals. The C1 and S parameters are measurements of the quality of the received signal. A camping availability indication shows whether the channel is available for use for camping. Certain channels may be designated as unavailable for camping by the service provider associated with the channel. signal strength is a measure of the strength of the received signals as is well known in the art. The cell selection information may be obtained from the signal in a number of different ways. For example, the signal strength or quality parameter may be calculated by the first receiver 130 or the cell selection information parser circuit 904 as is known in the art. The service provider associated with the first channel or camping availability indication may be obtained by the first receiver 130 demodulating the first signal 150 and the cell selection information parser circuit 904 reading the cell selection information from the demodulated signal.

In step 608, the multi-mode channel determination circuit 906 of the multi-mode wireless communication device 100 determines whether the channel is suitable to camp on. This determination may be made, for example, based on the quality rating of the received signal, a camping availability indication in the cell selection information, the signal strength of this signal, or using any other suitable method. If the channel is suitable to camp on, in step 610, the multi-mode channel determination circuit 906 of the multi-mode wireless communication device 100 determines whether a service provider associated with the channel is a desired service provider. The desired service provider may be, for example, a home service provider of the multi-mode wireless communication device 100 or it may be a service provider that last provided communication services to the multi-mode wireless communication device 100.

If the service provider associated with the channel is not the desired service provider, in step 624 the service provider list builder circuit 912 of the multi-mode wireless communication device 100 determines whether to update a service provider list 146 with the service provider associated with the channel. This determination can be made, for example, by checking to see if the service provider associated with the channel is already on the service provider list 146. The service provider is then added to the service provider list 146 if it is not already on the service provider list 146. In step 626, if the service provider list builder circuit 912 has determined that the service provider should be added to the service provider list 146, the service provider associated with the channel is added to the service provider list 146.

Regardless of whether the service provider should be added to the service provider list 146, in step 620, the multi-mode wireless communication device 100 determines whether there are additional channels to check by the first receiver 130. In general, the multi-mode wireless communication device 100 will have knowledge of what channels are possible for use in camping. This is because the channel bands allocated for communication service are usually allocated by government authorities and are well known. In addition, the multi-mode wireless communication device 100 may make an effort to narrow down the channels to scan by doing an initial check of power levels. For example, the multi-mode wireless communication device 100 may first measure the power levels on the possible channels and then only attempt to receive signals on those channels that have significant power. If there are additional channels to check, the multi-mode wireless communication device 100 changes the first receiver 130 to another channel in step 622.

In step 610, if the service provider associated with the channel is the desired service provider, in step 612, the multi-mode channel determination circuit 906 of the multi-mode wireless communication device 100 determines whether the first radio access technology is a preferred radio access technology. Whether a radio access technology is preferred can depend on, for example, a preference of a user of the multi-mode wireless communication device 100, a preference of the home service provider of the multi-mode wireless communication device 100, or the estimated cost of the communication service on the different radio access technologies. If the first radio access technology is the preferred radio access technology, in step 614, the multi-mode wireless communication device 100 camps on the channel. In step 616, the multi-mode wireless communication device 100 halts processing of the cell selection information 950, 952 obtained from signals received by the first and second receivers 130,132. The halting of processing may consist, for example, of turning off the first and second receivers 130, 132 or stopping the processor 112 from processing additional information received from the first and second receivers 130, 132.

If the first radio access technology is not the preferred radio access technology, in step 628 the multi-mode wireless communication device stores data representing the channel in the channel data storage circuit 908. In step 630, the multi-mode wireless communication device halts processing of the cell selection information obtained from signals received by the first receiver 130. This halting of processing may be accomplished, for example, by turning off the first receiver 130 or stopping the cell selection information processor circuit 904 from processing additional information received from the first receiver 130.

In step 632, the multi-mode wireless communication device 100 determines whether there are additional channels to check by the second receiver 132. If there are additional channels to check by the second receiver 132, the multi-mode wireless communication device 100 will wait until all the additional channels are checked by the second receiver 132. Once the channels have been checked by the second receiver 132, in step 634 the multi-mode channel determination circuit 906 of the multi-mode wireless communication device 100 determines whether the second receiver has found a suitable channel to camp on. In step 636, if the second receiver did not find a suitable channel to camp on, the multi-mode wireless communication device 100 camps on the channel represented by the stored data.

If there were no additional channels to check by the first receiver 130 in step 620, the multi-mode wireless communication device 100 halts processing of the cell selection information obtained from signals received by the first receiver 130 in step 640. The halting of processing may be accomplished, for example, by turning off the first receiver 130 or by stopping the processor 112 from processing information received from the first receiver 130. In step 642, the multi-mode wireless communication device 100 determines whether there are additional channels to check by the second receiver 132.

The method of FIGS. 6-7 reaches step 644 only after all of the possible channels have been checked by the first receiver 130 and the second receiver 132. In steps 644, the service provider selection circuit 910 of the multi-mode wireless communication device 100 selects a service provider from the service provider list 146. This selection may be made in a number of different ways. For example, if one of the service providers on the service provider list 146 is a home service provider for the multi-mode wireless communication device 100, the service provider selection circuit 910 may select the home service provider. Alternatively, the multi-mode wireless communication device 100 may have a preferred service provider list. The preferred service provider list contains a listing of service providers in order of priority. The service provider selection circuit 910 would then select the service provider on the service provider list 146 that is highest in priority on a preferred service provider list. In step 646, the multi-mode wireless communication device 100 then camps on a channel associated with the selected service provider.

Moving to the portion of the flowchart on FIG. 7, in step 704, the second receiver 132 associated with a second radio access technology receives a signal on a channel while the first receiver 130 is simultaneously operating. The second radio access technology may be, for example, CDMA, GSM, wideband CDMA, CDMA 2000, AMPS, IDEN, or any other suitable radio access technology. In step 708, the multi-mode channel determination circuit 906 of the multi-mode wireless communication device 100 determines whether the channel is suitable to camp on. This determination may be made, for example, based on the quality rating of the received signal, a camping availability indication in the cell selection information, the signal strength of this signal, or using any other suitable method. If the channel is suitable to camp on, in step 710, the multi-multi-mode channel determination circuit 906 determines whether a service provider associated with the channel is a desired service provider. The desired service provider may be, for example, a home service provider of the multi-mode wireless communication device 100 or it may be a service provider that last provided communication services to the multi-mode wireless communication device 100.

If the service provider associated with the channel is not the desired service provider, in step 724 the service provider builder circuit 912 determines whether to update a service provider list 146 with the service provider associated with the channel. This determination can be made, for example, by checking to see if the service provider associated with the channel is already on the service provider list 146. The service provider is then added to the service provider list 146 if it is not already on the service provider list 146. In step 726, if the service provider builder circuit 912 has determined that the service provider should be added to the service provider list 146, the service provider associated with the channel is added to the service provider list.

Regardless if whether the service provider should be added to the service provider list 146, in step 720, the multi-mode wireless communication device 100 determines whether there are additional channels to check by the second receiver 132. If there are additional channels to check, the multi-mode wireless communication device 100 changes the second receiver 132 to another channel in step 722.

In step 710, if the service provider associated with the channel is the desired service provider, in step 712, the multi-mode channel determination circuit 906 determines whether the second radio access technology is a preferred radio access technology. Whether radio access technology is preferred can depend on, for example, a preference of a user of the multi-mode wireless communication device 100, a preference of the home service provider of the multi-mode wireless communication device 100, or the estimated cost of the communication service on the different radio access technologies. If the second radio access technology is the preferred radio access technology, in step 714, the multi-mode wireless communication device 100 camps on the channel. In step 716, the multi-mode wireless communication device 100 halts processing of the cell selection information obtained from signals received by the first and second receivers 130,132. The halting of processing may consist, for example, of turning off the first and second receivers 130, 132 or stopping the processor 112 from processing additional information received from the first and second receivers 130, 132.

If the second radio access technology is not the preferred radio access technology, in step 728 the multi-mode wireless communication device stores data representing the channel in the channel data storage circuit 908. In step 730, the multi-mode wireless communication device halts processing of the cell selection information obtained from signals received by the second receiver 132. This halting of processing may be accomplished, for example, by turning off the second receiver 132 or stopping the processor 112 from processing additional information received from the second receiver 132.

In step 732, the multi-mode wireless communication device 100 determines whether there are additional channels to check by the first receiver 130. If there are additional channels to check by the first receiver 130, the multi-mode wireless communication device 100 will wait until all the additional channels are checked by the first receiver 130. Once the channels have been checked by the first receiver 130, in step 734 the multi-mode wireless communication device 100 determines whether the first receiver has found a suitable channel to camp on. In step 736, if the first receiver 130 did not find a suitable channel to camp on, the multi-mode wireless communication device 100 camps on the channel represented by the stored data.

In step 720 if there were no additional channels to check by the second receiver 132, in step 740 the multi-mode wireless communication device halts processing of the cell selection information obtained from the signals received by the second receiver 130. The halting of processing may be accomplished, for example, by turning off the second receiver 132 or by stopping the cell selection information parser circuit 904 from processing information received from the second receiver 132.

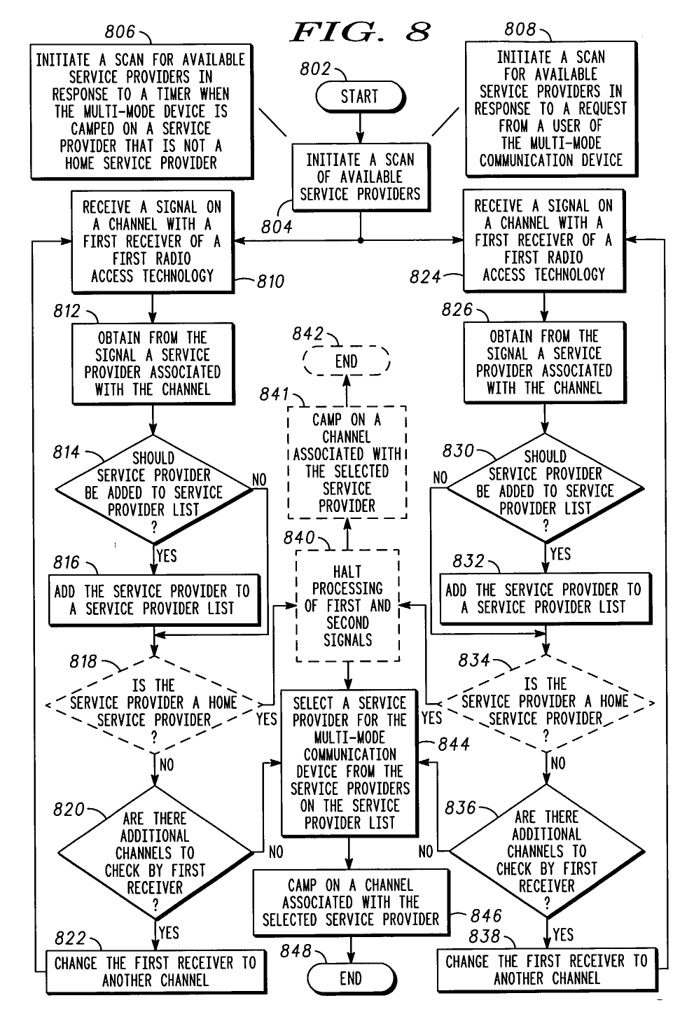

FIG. 8 is a flowchart illustrating a method for obtaining service provider information in the multi-mode wireless communication device 100. In step 804, a scan of available service providers is initiated. This scan can be initiated in a number of different ways, two of which are illustrated in steps 806 and 808. In step 806, the multi-mode wireless communication device 100 initiates a scan for available service providers in response to a timer (not shown) when the multi-mode wireless communication device 100 is camped on a service provider that is not a home service provider. Since the home service provider is likely to provide communication services at a lower cost than other service providers, it is desirable to camp on a channel associated with the home service provider when that is possible. When the multi-mode wireless communication device 100 is not camped on a channel associated with the home service provider, the multi-mode wireless communication device 100 periodically initiates a search to locate a channel associated with the home service provider. The length of time that the multi-mode wireless communication device 100 waits between scans for available service providers is determined by a timer (not shown). The timer may be set to a length of time specified in the SIM card 144, or the timer may be set to a default length of time, or some other suitable length of time may be used.

In an alternative embodiment, in step 808, the multi-mode wireless communication device 100 initiates the scan for available service providers in response to a request from a user of the multi-mode wireless communication device 100. The user of the multi-mode wireless communication device 100 may realize that the service provider currently providing communications service to the multi-mode wireless communication device 100 is undesirable for some reason such as, for example, cost. In that case, the user of the multi-mode wireless communication device 100 may initiate a scan to locate other service providers.

The method then proceeds to steps 810 and 824, which are executed simultaneously by the multi-mode wireless communication device 100. In step 810, the first receiver 130 associated with a first radio access technology receives a signal on a channel. The first radio access technology may be, for example, GSM, CDMA, wideband CDMA, CDMA 2000, AMPS, IDEN, or any other suitable radio access technology. In step 812, the cell selection information parser circuit 904 of the multi-mode wireless communication device 100 then obtains a service provider associated with the channel from the first signal. The service provider associated with the first channel may be obtained by the multi-mode communication device 100 in a number of different ways. The first receiver 130 may obtain the service provider by demodulating the received first signal, as is known in the art, and reading the service provider from the demodulated signal. The first receiver 130 would then send the service provider to the cell selection information parser circuit 904. The service provider may also be obtained by the cell selection information parser circuit 904 receiving the demodulated signal from the first receiver 130, demodulating the signal as is known in the art, and reading the service provider from the demodulated signal.

In step 814, the service provider list builder circuit 912 of the multi-mode wireless communication device 100 determines whether the service provider associated with the channel should be added to a service provider list 146. This determination can be made, for example, by checking to see whether the service provider is already on the service provider list 146. The service provider is then added to the service provider list 146 if it is not already on the service provider list 146. In step 816, if it was determined that the service provider should be added to the service provider list 146, the service provider list builder circuit 912 adds the service provider to the service provider list 146. In step 818, the multi-mode channel determination circuit 906 determines whether the service provider is a home service provider for the multi-mode wireless communication device 100. If the service provider is not a home service provider, in step 820, the multi-mode wireless communication device 100 determines whether there are additional channels to check by the first receiver of 130. If there are additional channels to check, then in step 822, the multi-mode wireless communication device 100 changes the first receiver 130 to another channel.

In step 818, if the scan is not user initiated and if the service provider was a home service provider for the multi-mode wireless communication device 100, then step in 840, the multi-mode wireless communication device 100 halts processing of the first and second signals. This may be done by turning off the first and second receivers 130, 132, or by stopping the processor 112 from processing additional information received from the first and second receivers 130, 132. In step 841, the multi-mode wireless communication device 100 camps on a channel associated with the home service provider.

In step 820, if there are no additional channels to check by the first receiver 130, in step 821, the multi-mode wireless communication device 100 determines if there are additional channels to check by the second receiver 132. If there are no additional channels to check by the second receiver 132, in step 844 the service provider selection circuit 910 selects a service provider from the service providers on the service provider list 146. This selection may be done in a number of different ways. For example, if one of these service providers on the service provider list 146 is a home service provider for the multi-mode wireless communication device 100, the home service provider may be selected. Alternatively, the multi-mode wireless communication device 100 may have a preferred service provider list. The preferred service provider list contains a listing of service providers in order of priority. The multi-mode wireless communication device 100 would then select the service provider on the service provider list 146 that is highest in priority on a preferred service provider list. In step 846, the multi-mode wireless communication device 100 then camps on a channel associated with the selected service provider.

In step 824, the second receiver 132 associated with a second radio access technology that is simultaneously operating while the first receiver 130 is operating receives a signal on a channel. The second radio access technology may be, for example, GSM, CDMA, wideband CDMA, CDMA 2000, AMPS, IDEN, or any other suitable radio access technology. In step 826, the cell selection information parser circuit 904 then obtains a service provider associated with the channel from the signal. The service provider associated with the channel may be obtained by the multi-mode communication device 100 in a number of different ways. The second receiver 132 may obtain the service provider by demodulating the received signal, as is known in the art, and reading the service provider from the demodulated signal. The second receiver 132 would then send the service provider to the cell selection information parser circuit 904. The service provider may also be obtained by the cell selection information parser circuit 904 receiving the signal from the second receiver 132 and reading the service provider from the demodulated signal.

In step 830, the multi-mode wireless communication device 100 determines whether the service provider associated with the channel should be added to a service provider list 146. This determination can be made, for example, by checking to see whether the service provider is already on the service provider list 146. The service provider is then added to the service provider list 146 if it is not already on the service provider list 146. In step 832, if it was determined that the service provider should be added to the service provider list 146, the service provider list builder circuit 912 adds the service provider to the service provider list 146. In step 834, the multi-mode channel determination circuit 906 determines whether the service provider is a home service provider for the multi-mode wireless communication device 100. If the service provider is not a home service provider, in step 836, the multi-mode wireless communication device 100 determines whether there are additional channels to check by the second receiver 132. If there are additional channels to check, then in step 838, the multi-mode wireless communication device 100 changes the second receiver 130 to another channel.

If at step 834 the service provider was a home service provider for the multi-mode wireless communication device 100, then steps 840 and 841 are executed as described above. In step 836, if there are no additional channels to check by the second receiver 132, in step 837, the multi-mode wireless communication device 100 determines if there are additional channels to check by the first receiver 130. If there are no additional channels to check by the first receiver 130, steps 844 and 846 are executed as described above.

In an alternate embodiment of the method illustrated in FIG. 8, steps 818, 840, 834, and 841 are not included in the method. In that case, the multi-mode wireless communication device 100 does not halt processing of the received signals when a channel associated with the home service provider is found. Instead, the multi-mode wireless communication device continues to add service providers to the service provider list 146 while it is checking each channel.

In other embodiments the multi-mode wireless communication device 100 has one or more processors. The memory 172 is coupled to the one or more processors. The memory 172 is a storage device, coupled to the one or more processors, having stored thereon executable instructions that, when executed by the one or more processors, cause the one or more processors to execute steps in accordance with the present invention such as those described with regard to FIGS. 3-8.

The preceding discussion has presented a number of related methods for utilizing a multi-mode wireless communication device including two receivers of different radio access technologies. In each of the methods, the two receivers simultaneously receive signals from which the multi-mode wireless communication device obtains information such as cell selection information or a service provider associated with the channel on which the signals are received. By simultaneously receiving the signals with the two receivers, the multi-mode wireless communication device is able to locate a channel to camp on, create a list of available service providers, or select a service provider quicker. Because these tasks are performed quicker, the multi-mode wireless communication device is able to go into power save mode sooner and the battery life of the multi-mode wireless communication device is increased. Furthermore, the multi-mode wireless communication device is able to provide communication functionality to the user of the multi-mode wireless communication device quicker.

It should be understood that the implementation of other variations and modifications of the invention and its various aspects will be apparent to those of ordinary skill in the art, and that the invention is not limited by the specific embodiments described. For example, the multi-mode wireless communication device 100 may have more than two receivers and/or transmitters that use more than two different radio access technologies. The multi-mode wireless communication device 100 may have multiple receivers and/or transmitters associated with a first radio access technology and one or more receivers and/or transmitters associated with a second radio access technology. The multi-mode wireless communications device 100 may not have all of the elements or may have other elements than those shown in FIG. 1. The multiple receivers having different radio access technologies may be utilized to simultaneously receive signals to obtain other information besides cell selection information or service provider information. It is therefore contemplated to cover by the present invention, any and all modifications, variations, or equivalents that fall within the spirit and scope of the basic underlying principles disclosed and claimed herein.

What is claimed is:

1. A method for channel selection in a multi-mode wireless communications device comprising:
receiving a first signal on a first channel with a first receiver associated with a first radio access technology;
obtaining, from the first signal, first cell selection information;
receiving a second signal on a second channel with a second receiver associated with a second radio access technology that is simultaneously operating while the first receiver is operating;
obtaining, from the second signal, second cell selection information; and
selecting a suitable channel to camp on based at least on the first and second cell selection information.

2. The method of claim 1 wherein at least one of the first cell selection information and the second cell selection information includes at least one of: a quality rating of the first signal, a service provider associated with the first channel, a camping availability indication, and signal strength of the first signal.

3. The method of claim 1 wherein the step of selecting includes the steps of:
determining from the first cell selection information whether the first channel is suitable to camp on; and
camping on the first channel when the first channel is suitable to camp on and the first radio access technology is preferred.

4. The method of claim 3 further comprising:
halting processing of the second cell selection information.

5. The method of claim 1 further including the steps of:
determining from the first cell selection information whether the first channel is suitable to camp on;
storing data representing the first channel when the first radio access technology is not preferred and the first channel is suitable to camp on; and
halting processing of signals received by the first receiver.

6. The method of claim 5 wherein the step of selecting includes the step of:
determining that no channels of the second radio access technology are suitable to camp on; and
camping on the channel represented by the stored data when no channels of the second radio access technology are suitable to camp on.

7. The method of claim 1 further comprising:
receiving a third signal on a third channel with the first receiver associated with a first radio access technology; and
obtaining, from the third signal, third cell selection information.

8. The method of claim 1 further including the steps of:
determining whether to update a service provider list with a service provider associated with the first channel; and
adding the service provider associated with the first channel to the service provider list when a determination to update the service provider list has been made.

9. The method of claim 1 further including the steps of:
determining from the first cell selection information whether the first channel is suitable to camp on;
determining, if the first channel is suitable to camp on, from the first cell selection information whether a service provider associated with the first channel is a preferred service provider; and
camping on the first channel if the service provider associated with the first channel is the preferred service provider.

10. The method of claim 9 further including the steps of:
adding, if the service provider associated with the first channel is not the preferred service provider, the service provider associated with the first channel to a service provider list;
receiving a third signal on a third channel with the first receiver of the first radio access technology; and
obtaining, from the third signal, third cell selection information.

11. The method of claim 1 further including the steps of:
determining from the first cell selection information whether the first channel is suitable to camp on;
determining, if the first channel is suitable to camp on, from the first cell selection information whether a service provider associated with the first channel is a preferred service provider; and
camping on the first channel if the service provider associated with the first channel is the preferred service provider and the first radio access technology is the preferred radio access technology.

12. The method of claim 1 further including the steps of:
determining from the first cell selection information whether the first channel is suitable to camp on;
determining, if the first channel is suitable to camp on, from the first cell selection information whether a service provider associated with the first channel is a preferred service provider;
storing data representing the first channel when the first access technology is not a preferred access technology if the service provider associated with the first channel is the preferred service provider and the first channel is suitable to camp on; and
halting processing of signals received by the first receiver.

13. The method of claim 12 further including the steps of:
determining that no channels of the second radio access technology are suitable to camp on; and
camping on the channel represented by the stored data when no channels of the second radio access technology are suitable to camp on.

14. A method for obtaining service provider information in a multi-mode wireless communications device comprising:
receiving a first signal on a first channel with a first receiver associated with a first radio access technology;
obtaining, from the first signal a first service provider associated with the first channel;
determining if the first service provider should be added to a service provider list;
receiving a second signal on a second channel with a second receiver associated with a second radio access technology that is simultaneously operating while the first receiver is operating;
obtaining, from the second signal a second service provider associated with the second channel; and
determining if the second service provider should be added to the service provider list.

15. The method of claim 14 further including the step of:
selecting, from the service providers on the service provider list, a service provider for the multi-mode communication device, wherein selecting includes at least one of selecting a home service provider as the service provider if the home service provider is on the service provider list and selecting a service provider from the service provider list that is highest in priority.

16. The method of claim 14 wherein the service provider list comprises a list of channels, radio access technologies associated with each of the channels, and a service provider associated with each of the channels.

17. The method of claim 14 further comprising:
initiating, prior to the steps of receiving, a scan for available service providers in response to a request from a user of the multi-mode communications device.

18. The method of claim 14 further comprising:
initiating, prior to the steps of receiving, a scan for available service providers in response to a timer when the multi-mode communication device is camped on a channel of a service provider that is not a home a service provider of the multi-mode communication device.

19. The method of claim 14 including the steps of:
determining, that the first service provider is a home service provider; and
halting processing of the second signal.

20. A method in a multi-mode wireless communication device comprising:
receiving a first signal on a first channel with a first receiver associated with a first radio access technology;
obtaining, from the first signal, first cell selection information including a first service provider associated with the first channel;
determining from the first cell selection information whether the first channel is suitable to camp on;
determining, if the first channel is suitable to camp on, if the first service provider should be added to a service provider list;
receiving a second signal on a second channel with a second receiver of the second transceiver that is simultaneously operating while the first receiver is operating;
obtaining, from the second signal, second cell selection information including a second service provider associated with the second channel;
determining from the second cell selection information whether the second channel is suitable to camp on;
determining, if the second channel is suitable to camp on, if the second service provider should be added to the service provider list; and
selecting a service provider from the service providers on the service provider list wherein selecting includes at least one of: selecting a home service provider as the service provider if the home service provider is on the service provider list and selecting a service provider from the service provider list that is highest in priority.

21. A multi-mode wireless communication device comprising:
a first receiver associated with a first radio access technology operable to receive a first signal on a first channel;
a second receiver associated with a second radio access technology operable to receive a second signal on a second channel while simultaneously operating while the first receiver is operating to receive the first signal;
a multi-mode channel selection circuit operably coupled to the first receiver and second receiver, the multi-mode channel selection circuit operable select a suitable channel to camp on based at least on first and second cell selection information that is obtained from the first and second signals that were received by the first and second receivers simultaneously.

22. The multi-mode wireless communication device of claim 21 further comprising:
a service provider list builder circuit coupled to the cell selection information parser circuit, the service provider list builder circuit operable to determine whether a first service provider associated with the first channel should be added to a service provider list.

23. The multi-mode wireless communication device of claim 22 further comprising:
a service provider selection circuit coupled to the multi-mode channel selection circuit, the service provider selection circuit operable to select a service provider for the multi-mode wireless communication device from the service providers on the service provider list.

24. The multi-mode wireless communication device of claim 21 further comprising:
a channel data storage circuit coupled to the multi-mode channel determination circuit, the channel data storage circuit that stores data representing the first channel when the first radio access technology is not preferred and the first channel is suitable to camp on; and
wherein the multi-mode channel determination circuit is further operable to camp on the channel represented by the stored data when no channels of the second radio access technology are suitable to camp on.

25. A multi-mode wireless communication device comprising:
one or more processors; and
a storage device, coupled to the one or more processors, having stored thereon executable instructions that, when executed by one or more processors, cause the one or more processors to:
receive a first signal on a first channel with a first receiver associated with a first radio access technology;
obtain, from the first signal, first cell selection information;
receive a second signal on a second channel with a second receiver associated with a second radio access technology that is simultaneously operating while the first receiver is operating;
obtain, from the second signal, second cell selection information; and
select a suitable channel to camp on based at least on the first and second cell selection information.

26. The multi-mode wireless communication device of claim 25 wherein the memory has stored thereon further executable instructions that, when executed by the at least one processor, causes at least one processor to:
determine from the first cell selection information whether the first channel is suitable to camp on; and
store data representing the first channel when the first radio access technology is not preferred and the first channel is suitable to camp on; and
halt processing of signals received by the first receiver.

27. The multi-mode wireless communication device of claim 26 wherein the memory has stored thereon further executable instructions that, when executed by the at least one processor, causes at least one processor to:
determine that no channels of the second radio access technology are suitable to camp on; and
camp on the channel represented by the stored data when no channels of the second radio access technology are suitable to camp on.

28. The multi-mode wireless communication device of claim 25 wherein the memory has stored thereon further executable instructions that, when executed by the at least one processor, causes at least one processor to:
obtain, from the first signal a first service provider associated with the first channel;
determine if the first service provider should be added to a service provider list;
obtain, from the second signal a second service provider associated with the second channel; and
determine if the second service provider should be added to the service provider list.
